(19) United States
(12) Patent Application Publication
(10) Pub. No.: US 2026/0024138 A1
(43) Pub. Date: Jan. 22, 2026

(54) APPARATUS AND METHOD FOR PREDICTING FUNGIBLE ASSET REQUIREMENT USING STATISTICAL RELATIONSHIP MODELING

(71) Applicant: 102202203 Saskatchewan LTD., Saskatoon (CA)

(72) Inventor: Dennis E. Bulani, Saskatchewan (CA)

(73) Assignee: 102202203 Saskatchewan LTD., Saskatoon (CA)

(21) Appl. No.: 18/775,388

(22) Filed: Jul. 17, 2024

(51) Int. Cl. G06Q 40/06; G06F 16/951; G06Q 30/0204

(52) U.S. Cl. CPC G06Q 40/06; G06Q 30/0205; G06F 16/951

(57) ABSTRACT

An apparatus and method for predicting fungible asset requirement using statistical relationship modeling. The apparatus includes at least a processor and a memory communicatively connected to the at least a processor. The memory instructs the processor to process a plurality of multimodal data associated with a first fungible asset. The memory instructs the processor to generate, using a correlation module, a correlation matrix as a function of the plurality of multimodal data. The memory instructs the processor to generate a prediction module as a function of the correlation matrix. The memory instructs the processor to generate at least an acquisition outline for a second fungible asset using the prediction module. The memory instructs the processor to transmit the at least an acquisition outline to a downstream device.

### FIELD OF THE INVENTION

The present invention generally relates to the field of data management and analysis. In particular, the present invention is directed to an apparatus and a method for predicting fungible asset requirement using statistical relationship modeling.

### BACKGROUND

Existing methods for predicting commodity demand often rely on historical data and basic analytical techniques. These methods may not account for the complex relationships between various factors influencing commodity prices and demand. Current approaches may lack the ability to integrate diverse data sources such as economic indicators, weather patterns, and geopolitical events. This limitation may result in less accurate predictions and suboptimal purchasing strategies, leading to inefficiencies and increased costs.

### SUMMARY OF THE DISCLOSURE

In an aspect, an apparatus for predicting fungible asset requirement using statistical relationship modeling includes at least a processor and a memory communicatively connected to the at least a processor. The memory contains instructions configuring the processor to process a plurality of multimodal data associated with a first fungible asset, generate, using a correlation module, a correlation matrix as a function of the plurality of multimodal data, wherein generating the correlation matrix comprises comparing a first variable of the plurality of multimodal data to a second variable of the plurality of multimodal data, identify at least a correlation between the first variable and the second variable based on the comparison, and generate the correlation matrix as a function of the at least a correlation, generating a prediction module as a function of the correlation matrix, generate at least an acquisition outline for a second fungible asset using the prediction module, and transmit the at least an acquisition outline to a downstream device communicatively connected to the at least a processor.

In another aspect, a method for predicting fungible asset requirement using statistical relationship modeling includes processing a plurality of multimodal data associated with a first fungible asset, generating, using a correlation module, a correlation matrix as a function of the plurality of multimodal data, wherein generating the correlation matrix comprises comparing a first variable of the plurality of multimodal data to a second variable of the plurality of multimodal data, identifying at least a correlation between the first variable and the second variable based on the comparison, and generating the correlation matrix as a function of the at least a correlation, generating a prediction module as a function of the correlation matrix, generating at least an acquisition outline for a second fungible asset using the prediction module, and transmitting the at least an acquisition outline to a downstream device communicatively connected to the at least a processor.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus for predicting fungible asset using statistical relationship modeling;

FIG. 2 is a block diagram of an exemplary machine-learning process;

FIG. 3 is a diagram of an exemplary embodiment of a neural network;

FIG. 4 is a diagram of an exemplary embodiment of a node of a neural network;

FIG. 5 is an exemplary embodiment of an immutable sequence listing;

FIG. 6 is an exemplary illustration of the graphical user interface;

FIG. 7 is a block diagram of an exemplary method for predicting fungible asset requirement using statistical relationship modeling;

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for predicting fungible asset requirement using statistical relationship modeling. The apparatus includes at least a computing device comprised of a processor and a memory communicatively connected to the processor. The memory instructs the processor to process a plurality of multimodal data associated with a first fungible asset. The processor generates, using a correlation module, a correlation matrix as a function of the plurality of multimodal data, wherein generating the correlation matrix comprises comparing a first variable of the plurality of multimodal data to a second variable of the plurality of multimodal data, identifying at least a correlation between the first variable and the second variable based on the comparison, and generating the correlation matrix as a function of the at least a correlation. The processor generates a prediction module as a function of the correlation matrix. The processor generates at least an acquisition outline for a second fungible asset using the prediction module. Additionally, the processor transmits the at least an acquisition outline to a downstream device communicatively connected to the at least a processor.

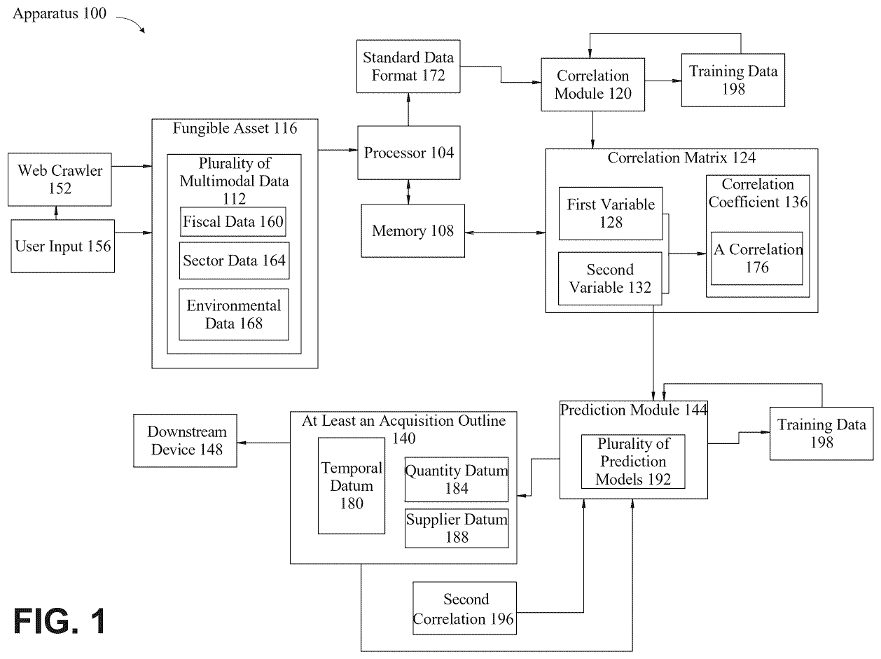

Referring now to FIG. 1, an exemplary embodiment of apparatus 100 for predicting fungible asset requirement using statistical relationship modeling is illustrated. Apparatus 100 may include a processor 104 communicatively connected to a memory 108. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor 104 may access the information from primary memory.

Still referring to FIG. 1, apparatus 100 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, apparatus 100 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the apparatus computing device. In one or more embodiments, computing device may transmit processes to server wherein computing device may conserve power or energy.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 104 processes a plurality of multimodal data 112 associated with first fungible asset 116. As used in this disclosure, “multimodal data” is information that encompasses multiple types of data or data sources. For example, without limitation, this may include data from text, images, audio, video, sensor, and the like. In a non-limiting example, multimodal data may be utilized to make more informed decisions and mitigate risks. For instance, without limitation, historical fuel price data, economic indicators, and geopolitical events may be integrated to predict future price movements. Additionally, weather patterns and forecasts, which can impact fuel supply and demand, may be incorporated alongside data from financial markets that show trends in currency exchange rates and commodity prices. Without limitation, a comprehensive view may be created to help in making strategic hedging decisions, by combining these diverse data sources, potentially stabilizing costs and protecting against volatile fuel prices. As used in this disclosure, a “fungible asset” is an item that is interchangeable with other individual items of the same type. In a non-limiting example, fungible asset 116 may include a commodity, such as, without limitation, lumber, oil, gold, and the like.

With continued reference to FIG. 1, processor 104 may integrate historical price data, current market trends, and economic indicators to analyze the value of fungible asset 116, such as, contracts for the sale of crude oil. Continuing, multimodal data 112, such as geopolitical events and weather forecasts, may be included to assess their potential impact on supply and demand of crude oil, further informing trading strategies. In another non-limiting example, processor 104 may combine multimodal data 112, such as, exchange rate data, interest rate trends, and economic performance indicators from multiple countries to predict future currency movements help make informed decisions about fungible asset such as currency exchange futures to hedge against unfavorable shifts in exchange rates. In another non-limiting example, processor 104 may process multimodal data 112 including, without limitation, financial statements, market sentiment analysis from news sources, and technical indicators from stock price movements to provide a comprehensive assessment of fungible asset such as stock options, and help guide decisions on buying or selling options to mitigate investment risks.

Still referring to FIG. 1, processor 104 generates, using correlation module 120, correlation matrix 124, wherein generating correlation matrix 124 comprises comparing first variable 128 of the plurality of multimodal data 112 to second variable 132 of the plurality of multimodal data 112, identifying at least a correlation between the first variable and the second variable based on the comparison, and generating correlation matrix 124 as a function of the at least a correlation. As used in this disclosure, a “correlation module” is an algorithm designed to measure and analyze the statistical relationship between two or more variables. Without limitation, correlation module 120 may use several algorithms to analyze and quantify the relationships between variables. For example, correlation module 120 may use Pearson's Correlation Coefficient, Spearman's Rank Correlation Coefficient, Kendall's Tau, Mutual Information, Canonical Correlation Analysis (CCA), Cross-Correlation, Cosine Similarity, Principal Component Analysis (PCA), and the like. In a non-limiting example, the primary function or correlation module 120 may be to determine trends and/patterns between two or more variables. Without limitation, correlation module 120 may utilize machine learning to enhance its predictive capabilities. Without limitation, correlation module 120 may be used to determine trends and patterns between multiple variables, providing valuable insights for predicting fungible asset requirements. In a non-limiting example, correlation module 120 may be trained using a variety of input data. For instance, without limitation, the training data 198 may include historical price data, trading volumes, economic indicators, and geopolitical events. Without limitation, machine learning models such as regression analysis, neural networks, or support vector machines may be employed to identify and learn the complex relationships between these variables. In a non-limiting example, correlation module 120 may process vast amounts of historical data and correlation module 120 may uncover patterns that are not immediately apparent through traditional analysis methods. Continuing, correlation module 120 may undergo supervised learning where it may be fed labeled datasets. In a non-limiting example, the labeled datasets may contain known outcomes, such as past market conditions and corresponding asset prices. Without limitation, correlation module 120 may learn to associate specific patterns in the input data with the known outcomes, thereby gradually improving its ability to provide insights into how the plurality of multimodal data 112 is interrelated. Continuing, cross-validation techniques may be applied to correlation module 120 to ensure that correlation module 120 generalizes well to new, unseen data, enhancing its robustness and reliability. Cross-validation techniques may include various methods to assess the performance of correlation module 120. For instance, k-fold cross-validation may be applied. K-fold cross-validation is where the dataset is divided into k subsets, and the model is trained on k−1 of these subsets while the remaining subset is used for validation. Continuing, this process is repeated k times, with each subset being used exactly once as the validation data. Another cross-validation technique may include leave-one-out cross-validation (LOOCV), which is a special case of k-fold cross-validation where k is equal to the number of data points in the dataset. In the LOOCV technique, the correlation model may be trained on all data points except one, which is used for validation. This process is repeated for each data point in the dataset. In another non-limiting example, stratified k-fold cross-validation may be particularly useful for imbalanced datasets. Stratified k-fold cross-validation is where the data is divided into k subsets in such a way that each subset has approximately the same percentage of samples of each target class as the original dataset. Additionally and or alternatively, time-series cross-validation may be used. Time-series cross-validation may be suitable for time-dependent data. Time-series cross-validation is where the training set is composed of observations up to a certain time point, and the validation set includes observations from the subsequent time period. This process is repeated by moving the time point forward.

With continued reference to FIG. 1, the input data for training correlation module 120 may include a plurality of multimodal data 112 and correlation module 120 output may include insights into how the plurality of multimodal data 112 is interrelated. For example, without limitation, correlation module 120 may receive as input historical price data, which may help correlation module 120 understand past market trends and volatility. Continuing, production volumes may be included to provide insights into supply levels, which correlation module 120 may correlate with demand. In another non-limiting example, economic indicators, such as GDP growth, may also be used to factor in broader economic conditions that impact commodity consumption. In another non-limiting example, weather data may be used as input training data 198 to help correlation module 120 account for environmental factors that may affect agricultural production and supply chains. Continuing, without limitation, trade volumes may be included to provide insights into the flow of fungible assets between regions, aiding correlation module 120 in understanding global demand and supply dynamics. Continuing, inventory levels may be used to indicate current stockpiles, which correlation module 120 may use to assess the availability and potential shortages or surpluses in the market. Without limitation, other possible data sources may include geopolitical events, which might impact supply chain dynamics and fungible asset availability and financial market data, such as trends in currency exchange rates and fungible asset prices, may also be used to train correlation module 120 to provide a comprehensive view of market conditions.

With continued reference to FIG. 1, correlation module 120 may reveal that historical price data and weather patterns have a strong correlation, indicating that adverse weather conditions tend to drive up fungible asset prices. Continuing, this insight may help businesses anticipate price spikes and adjust their purchasing strategies accordingly. Additionally and or alternatively, correlation module 120 may uncover relationships between economic indicators and market trends, such as a correlation between GDP growth and increased demand for certain fungible assets. Continuing, this information may be valuable for making long-term investment decisions. In another non-limiting example, correlation module 120 may identify geopolitical events that significantly impact supply chain dynamics, leading to fluctuations in fungible asset availability. Continuing, this insight may assist in risk management and contingency planning. Without limitation, correlation module 120 ability to discern these patterns and relationships within the plurality of multimodal data 112 may provide actionable insights that enhance decision-making processes across various domains.

With continued reference to FIG. 1, as used in this disclosure, a “correlation matrix” is a matrix that shows the correlation between multiple variables. In a non-limiting example, correlation matrix 124 may be represented by a table with numerical values which indicate a degree to which one variable is related to another. In a non-limiting example, correlation module 120 may generate correlation matrix 124 by first comparing first variable 128 of the plurality of multimodal data 112 to second variable 132 of the plurality of multimodal data 112. As used in this disclosure, a “first variable” is an initial variable being considered for examination or comparison. As used in this disclosure, a “second variable” is a subsequent variable being considered for examination or comparison to first variable 128. As used in this disclosure, a “relationship” is the connection or association between two or more variables. As used in this disclosure, a “correlation coefficient” is a statistical measure that quantifies the degree and direction of the relationship between two variables. In a non-limiting example, correlation coefficient 136 may indicate how strongly and in what manner (positive or negative) two variables are related to each other. For instance, correlation module 120 may compare historical price data to weather patterns. Continuing, correlation module 120 may generate correlation coefficient 136 based on the relationship between these two variables, quantifying how strongly they are related. In a non-limiting example, correlation matrix 124 may show, using a numerical value, a high positive correlation between adverse weather conditions and increased fungible asset prices, indicating that poor weather tends to drive up prices. Conversely, correlation matrix 124 may show a negative correlation between inventory levels and fungible asset prices, suggesting that higher stockpiles are associated with lower prices. Without limitation, correlation matrix 124 may use numerical values to indicate the strength and direction of the relationships between variables. For instance, correlation coefficient 136 close to 1 might indicate a strong positive correlation, meaning that as one variable increases, the other variable tends to increase as well. Conversely, correlation coefficient 136 close to −1 might indicate a strong negative correlation, meaning that as one variable increases, the other variable tends to decrease. For example, without limitation, using a numerical value of 0.85 might suggest a strong positive correlation between historical price data and weather patterns, indicating that adverse weather conditions are closely associated with higher commodity prices. Conversely, a numerical value of −0.75 might suggest a strong negative correlation between inventory levels and commodity prices, indicating that higher stockpiles are associated with lower prices. Without limitation, weaker correlations may be indicated by numerical values closer to 0. For instance, correlation coefficient 136 of 0.2 might suggest a weak positive correlation, meaning that there is a slight tendency for the two variables to increase together, but the relationship is not strong. Similarly, correlation coefficient 136 of −0.3 might suggest a weak negative correlation, indicating a slight tendency for one variable to decrease as the other increases. Without limitation, using numerical values for correlation coefficient 136, correlation matrix 124 may provide a clear and quantifiable way to understand the relationships between different variables and help to identify which factors are most strongly associated with the outcomes of interest. In another non-limiting example correlation matrix 124 may show the relationship between economic indicators and market trends. Continuing, correlation matrix 124 may reveal a strong positive correlation between GDP growth and increased demand for certain fungible assets, providing valuable insights for long-term investment decisions. Additionally, correlation module 120 might identify significant correlations between geopolitical events and supply chain dynamics. For instance, correlation matrix 124 may show that political instability in a major oil-producing region is strongly correlated with fluctuations in oil prices.

Still referring to FIG. 1, processor 104 generates prediction module 144 as a function of the correlation matrix 124. Additionally, processor 104 generates at least acquisition outline 140 for a second fungible asset 116 using the prediction module 144. As used in this disclosure, an “acquisition outline” is a purchase schedule that details the planned procurement of fungible assets over a specific period of time. In a non-limiting example, acquisition outline 140 may include a structured timeline and framework for acquiring fungible assets, ensuring that procurement activities are conducted in an organized and timely manner. In another non-limiting example, acquisition outline 140 may help with budgeting, forecasting, and aligning procurement strategies with organizational goals. For example, without limitation, in a manufacturing company, acquisition outline 140 may be used to schedule the purchase of raw materials. Continuing, acquisition outline 140 may specify certain quantities of steel and aluminum to be acquired monthly to meet production targets for the next quarter. Continuing by detailing these purchases in advance, the company may secure better pricing and ensure a steady supply of materials, thus avoiding production delays. In another non-limiting example, acquisition outline 140 may detail the procurement schedule for various services and equipment needed for infrastructure development. Continuing, the outline may indicate that construction machinery and labor services are to be contracted in specific phases of a project. Continuing, this structured approach may help in maintaining project timelines and adhering to budget constraints. In another non-limiting example, in the context of a retail business, acquisition outline 140 may be used to plan inventory purchases based on seasonal demand. For instance, without limitation, acquisition outline 140 may indicate increased orders for winter clothing and accessories starting in September, ensuring that the store is well-stocked for the holiday season. Continuing, this proactive scheduling may enhance inventory management and sales forecasting.

With continued reference to FIG. 1, as used in this disclosure, a “prediction module” is an algorithm designed to forecast future values or trends based on historical data and identified patterns. In a non-limiting example, prediction module 144 may use statistical techniques and machine learning models to analyze past behavior and make informed predictions about future outcomes. Without limitation, prediction module 144 may assist in decision-making by generating the acquisition schedule and providing anticipatory insights to help manage risks, optimize strategies, and improve planning processes.

For instance, without limitation, in the context of supply chain management, prediction module 144 may analyze historical sales data, inventory levels, and market trends to forecast future product demand. By doing so, it may help businesses optimize their inventory levels, reducing the risk of overstocking or stockouts. Similarly, in financial markets, prediction module 144 may be used to predict stock prices or market movements by analyzing historical price data, trading volumes, and economic indicators. Without limitation, prediction module 144 may enable traders and investors to make more informed investment decisions, potentially improving their financial returns. In another non-limiting example, in the context of healthcare, prediction module 144 may forecast patient admission rates by examining historical hospital admission records, seasonal trends, and population health data. Continuing, such predictions may assist hospital administrators in resource planning, ensuring that adequate staff and medical supplies are available to meet patient needs. Additionally and or alternatively, in weather forecasting, prediction module 144 may use historical weather data, satellite images, and climate models to predict future weather conditions. These predictions may help individuals and organizations prepare for adverse weather events, enhancing safety and reducing potential damages.

With continued reference to FIG. 1, prediction module 144 may analyze the data by leveraging correlation matrix 124 to identify significant relationships and patterns among various variables. For instance, without limitation, prediction module 144 may analyze historical sales data, inventory levels, and market trends to forecast future product demand. Without limitation, prediction module 144 may receive correlation matrix 124 from correlation module 120 and examine the historical sales data to understand past trends and seasonal variations to generate the at least acquisition outline 140. Continuing, prediction module 144 may analyze inventory levels to assess current stock and identify potential shortages or surpluses. Additionally and or alternatively, prediction module 144 may receive, as input data, market trends, such as changes in consumer preferences or economic conditions, to predict future demand. Continuing, prediction module 144 may generate a comprehensive forecast of future product demand by using correlation matrix 124. For example, correlation module 120 may identify a strong positive correlation between increased marketing efforts and higher sales volumes and prediction module 144 may use that insight to predict that a planned marketing campaign will likely boost future sales of a specific fungible asset and prediction module 144 may generate acquisition outline 140 that includes increased inventory orders to meet the anticipated demand. In another non-limiting example, prediction module 144 may receive as input correlation matrix 124 for economic indicators and product demand. Continuing, prediction module 144 may find that rising GDP growth is associated with higher demand for luxury goods. Continuing, based on prediction module 144 analysis, prediction module 144 may generate acquisition outline 140 that schedules increased purchases of luxury items in anticipation of higher consumer spending. Without limitation, by analyzing these various data points and leveraging the insights from correlation matrix 124, prediction module 144 may generate acquisition outline 140 that optimizes inventory levels, reduces the risk of stockouts or overstocking, and aligns procurement strategies with anticipated market conditions.

With continued reference to FIG. 1, prediction module 144 may leverage machine learning algorithms to continuously improve its accuracy over time. For example, without limitation, prediction module 144 may employ techniques such as linear regression, neural networks, or time series analysis to refine its predictions based on new data inputs. Continuing, this adaptability may allow prediction module 144 to remain relevant and effective in dynamic environments where conditions and variables frequently change. Continuing, prediction module 144 may be continuously updated with new data to refine prediction module 144 forecasts. Continuing, this ongoing learning process may involve feeding prediction module 144 real-time data, such as current market prices, breaking news events, and updated economic forecasts. Continuing, by adapting to new information, prediction module 144 may maintain its accuracy and relevance, providing reliable support for predicting fungible asset requirements and aiding in strategic decision-making processes. For example, without limitation, in predicting the requirements for crude oil futures, input data may include historical price fluctuations, global supply and demand statistics, weather forecasts affecting oil production regions, news sentiment analysis regarding geopolitical events, and the like, and may be updated with new information every day, hour, minute, second, and the like. As used in this disclosure, a “crude oil future” is a standardized contract traded on futures exchanges that obligate the buyer to purchase, and the seller to sell, a specific quantity of crude oil at a predetermined price on a specified future date. In a non-limiting example, crude oil futures are a type of derivative financial instrument, meaning their value is derived from the price of the underlying fungible asset, which in this case is crude oil.

With continued reference to FIG. 1, prediction module 144 may output at least acquisition outline 140. For example, prediction module 144 may provide in the at least acquisition outline 140 forecasts on the future demand for specific fungible assets, optimal purchasing times, and potential price movements. In a non-limiting example, prediction module 144 outputs may be visualized through graphs, trend lines, and heat maps, making it easier for decision-makers to interpret the results and take appropriate actions. In a non-limiting example, prediction module 144 may suggest buying or selling strategies for fungible assets based on predicted market conditions.

Still referring to FIG. 1, processor 104 transmits at least acquisition outline 140 to a downstream device 148. As used in this disclosure, a “downstream device” is an electronic device that presents information to the entity. In some cases, downstream device may be configured to project or show visual content generated by computers, video devices, or other electronic mechanisms. In some cases, downstream device may include a liquid crystal display (LCD), a cathode ray tube (CRT), a plasma display, a light emitting diode (LED) display, and any combinations thereof. In a non-limiting example, one or more display devices may vary in size, resolution, technology, and functionality. Downstream device may be able to show any data elements and/or visual elements as listed above in various formats such as, textural, graphical, video among others, in either monochrome or color. Downstream device may include, but is not limited to, a smartphone, tablet, laptop, monitor, tablet, and the like. Downstream device may include a separate device that includes a transparent screen configured to display computer generated images and/or information. In some cases, display device may be configured to present a graphical user interface (GUI) to a user, wherein a user may interact with a GUI. In some cases, a user may view a GUI through display. Additionally, or alternatively, processor 104 be connected to downstream device. In one or more embodiments, transmitting acquisition outline 140 may include displaying acquisition outline 140 at downstream device 148 using a visual interface.

With continued reference to FIG. 1, processor 104 may be configured to receive the plurality of multimodal data 112 using one or more web crawler 152 and user input 156. As used in this disclosure, a “web crawler” is an automated software program designed to systematically browse and index web pages on the internet. In a non-limiting example, web crawler 152 may use a list of URLs, also known as “seeds,” to browse and extract hyperlinks to other pages, adding the other pages to the list of sites to be browsed. Without limitation, web crawler 152 may be used to create a comprehensive index of web content. Without limitation, web crawler 152 may collect data from web pages, such as text, images, and metadata, which then may be processed and stored in a database. In a non-limiting example, web crawler 152 may operate automatically without human intervention. In another non-limiting example, web crawler 152 may follow predefined rules and algorithms to determine which pages to visit and how often to revisit them. Without limitation, to prevent overloading web servers, web crawler 152 may adhere to the “robots.txt” file on websites, which specifies which parts of the site should not be crawled, and they may limit the number of requests sent to a server within a certain time frame to avoid overwhelming it. In another non-limiting example, web crawler 152 may collect a plurality of multimodal data 112 related to industry trends, consumer behavior, and market conditions from various online sources. As used in this disclosure, a “user input” is data or information provided by a user to a system, application, or device. In a non-limiting example, this input may be used to interact with the system, provide instructions, or supply data that the system needs to process. In a non-limiting example, user input 156 may play a crucial role in guiding the data collection and analysis process. For example, without limitation, user input 156 may include specific keywords or search queries into the apparatus to instruct web crawler 152 on what type of data to collect. In a non-limiting example, this may include specifying particular fungible assets, geographic regions, or time periods of interest. Additionally and or alternatively, user input 156 may include parameters such as date ranges, geographic locations, filters, and the like, that refine the scope of web crawler 152's search and data collection. Without limitation, user input 156 may include date ranges to help narrow down the data to a specific timeframe. Without limitation, user input 156 may also include relevant data sources, such as specific “seed” websites or databases that are known to contain valuable information relevant to fungible asset 116.

With continued reference to FIG. 1, wherein the plurality of multimodal data 112 comprises a plurality of fiscal data 160, sector data 164, and environmental data 168. As used in this disclosure, “fiscal data” is financial information related to an organization or entity that manages revenues, expenditures, budgets, and overall economic performance. In a non-limiting example, fiscal data 160 may be essential for understanding and managing public finances, formulating fiscal policies, and ensuring transparency and accountability in the use of public resources. Fiscal data 160 includes various financial metrics such as tax revenues, government spending, budget surpluses or deficits, public debt levels, and key economic indicators like GDP and inflation rates. In a non-limiting example, fiscal data 160 may include details on tax revenues collected from income taxes, sales taxes, and property taxes, providing insight into the entity's income sources. Continuing, fiscal data 160 may also include information on the entity's spending helping to track how funds are allocated. Additionally and or alternatively, fiscal data 160 may show the budget balance, indicating whether the entity is running a surplus or deficit. In another non-limiting example, public debt figures, including the national debt and debt-to-GDP ratio, may also be part of fiscal data 160, reflecting a country's borrowing and debt repayment capacity. In a non-limiting example, economic indicators like GDP and inflation rates may help assess the overall economic performance and stability of a country. In a non-limiting example, prediction module may use fiscal data 160 to predict fungible asset requirements by analyzing an entity's financial performance and economic indicators. For example, without limitation, a company in the commodities market may use fiscal data 160 such as historical revenue, expenditure patterns, and profit margins to forecast the demand for raw materials like metals or agricultural products. By inputting this fiscal data 160 into correlation module 120, the company may identify trends and seasonal fluctuations that affect its production needs. Continuing, prediction module 144 may then use the generated correlation matrix to analyze past financial performance data to predict future cash flows and determine the optimal times to purchase or sell commodities, ensuring cost-efficiency and maintaining adequate inventory levels. In another non-limiting example, an energy company may input data on its operational costs, capital expenditures, and historical fuel consumption into the module. Without limitation, this data may permit prediction module 144 to forecast future fuel requirements based on projected production levels and market conditions. For instance, without limitation, by analyzing patterns in historical spending on fuel and energy consumption, prediction module 144 may generate acquisition outline 140 wherein acquisition outline 140 predicts periods of high demand and recommend procurement strategies to avoid price spikes and supply shortages. Without limitation, the acquisition schedule may help the entity manage its budget more effectively, optimize its purchasing decisions, and ensure a stable supply of essential energy commodities.

With continued reference to FIG. 1, as used in this disclosure, “sector data” is information that pertains to specific segments of an economy or market, often categorized by industry or type of economic activity. In a non-limiting example, sector data 164 may include various metrics such as production levels, employment figures, sales, investment, and other relevant financial and operational statistics. Without limitation, sector data 164 may be important for understanding the performance, trends, and health of individual sectors within the broader economy, aiding businesses, investors, and policymakers in making informed decisions. For example, without limitation, in the manufacturing sector, sector data 164 may encompass information on output volume, capacity utilization, and inventory levels. Continuing, this data may help companies optimize production schedules and manage supply chains. In the retail sector, sector data 164 may include sales figures, foot traffic, and consumer spending patterns, which may guide retailers in adjusting inventory and marketing strategies. In another non-limiting example, in the technology sector, sector data 164 may include of research and development expenditures, patent filings, and market share statistics, providing insights into innovation and competitive dynamics. In another non-limiting example, in the healthcare sector, data on patient demographics, treatment outcomes, and healthcare spending may be used to improve service delivery and plan for future resource needs. In another non-limiting example, in the energy sector, data on energy production, consumption, and prices may assist in forecasting demand and managing resources efficiently. In another non-limiting example, in the financial sector, sector data 164 may include loan volumes, interest rates, and stock market performance and sector data 164 may be used for assessing economic stability and growth opportunities. In a non-limiting example, prediction module 144 may use sector data 164 to forecast fungible asset requirements by analyzing trends and patterns unique to each sector. For example, in the agricultural sector, prediction module 144 may incorporate data on crop yields, seasonal weather patterns, soil health, and pest outbreaks. Continuing, prediction module 144 may use that information to predict the future availability and demand for commodities like wheat, corn, and soybeans. For instance, if correlation coefficient 136 indicates a trend of below-average rainfall in major farming regions, prediction module 144 may predict lower crop yields and higher prices for these commodities. Additionally, prediction module 144 may factor in global demand shifts, such as increased consumption in emerging markets, to provide a more comprehensive forecast. Without limitation, acquisition outline 140 may allow agribusinesses, traders, and investors to make informed decisions regarding purchasing, selling, and hedging strategies. In another non-limiting example, in the energy sector, prediction module 144 may utilize data on oil production rates, geopolitical events, regulatory changes, and technological advancements in energy extraction and consumption. For example, without limitation, by analyzing data on political instability in major oil-producing countries, prediction module 144 may predict potential disruptions in oil supply. Furthermore, without limitation, prediction module 144 may assess trends in renewable energy adoption and government policies promoting clean energy, which may affect the future demand for fossil fuels. By integrating these diverse data points, prediction module 144 may accurately forecast the supply and demand dynamics of oil, natural gas, and other energy commodities. Without limitation, energy companies and investors may use acquisition outline 140s to adjust their strategies, ensuring they are prepared for market fluctuations and regulatory shifts. Continuing, acquisition outline 140 may assist in managing risks and capitalizing on opportunities in the volatile energy market.

With continued reference to FIG. 1, as used in this disclosure, “environmental data” is information that pertains to the state of the natural environment and the factors that influence its condition. In a non-limiting example, environmental data 168 may include a wide range of variables related to air, water, soil, ecosystems, and climate. Continuing, environmental data 168 may include assessing the impact of human activities, and guiding policies aimed at protecting and preserving natural resources. For example, without limitation, environmental data 168 may include air quality data may include measurements of pollutants such as carbon dioxide (CO2), sulfur dioxide (SO2), nitrogen oxides (NOx), particulate matter (PM2.5 and PM10), and ozone (O3). Continuing, these measurements may be collected from various monitoring stations and used to evaluate the health of the atmosphere, track pollution sources, and the like. Without limitation, air quality data may also be used in public health studies to understand the impact of pollution on respiratory diseases and overall health. In another non-limiting example, environmental data 168 may include water quality data which may include parameters such as pH, temperature, dissolved oxygen, turbidity, and concentrations of contaminants like heavy metals, pesticides, nitrates, and the like. Continuing, this data may be collected from rivers, lakes, oceans, and groundwater sources to assess the health of aquatic ecosystems, ensure safe drinking water, and monitor the effects of industrial discharges and agricultural runoff. Water quality data may help in managing water resources, protecting biodiversity, and developing regulations to prevent water pollution. In another non-limiting example, environmental data 168 may include soil data. Soil data may encompass information on soil composition, moisture levels, nutrient content, contamination by hazardous substances, and the like. Without limitation, soil data may be crucial for agriculture, land management, environmental remediation, and the like. Without limitation, soil data may provide insight on soil health, fertility, suitability for various crops, and the like. In another non-limiting example, environmental data 168 may include climate data. Climate data may include temperature records, precipitation levels, humidity, wind speeds, atmospheric pressure, and the like. Without limitation climate data may be collected from weather stations, satellites, climate models, and the like to study weather patterns, predict extreme weather events, and understand long-term climate change trends. In a non-limiting example, climate data may be important for informing climate policy, disaster preparedness, sustainable development planning, and the like.

With continued reference to FIG. 1, environmental data 168 may significantly affect the determination of fungible asset requirements by influencing various factors such as resource availability, supply chain stability, energy demand, and investment strategies. For instance, without limitation agricultural commodities like wheat, corn, and soybeans depend heavily on climate conditions. Continuing, accurate data on rainfall, temperature, and soil moisture helps predict crop yields, enabling prediction module 144 to forecast supply levels and adjust acquisition outline 140 accordingly. Without limitation, extreme weather events, such as hurricanes, floods, and droughts, may disrupt supply chains for commodities like oil and natural gas. In a non-limiting example, processor 104 may provide prediction module this information to assess these risks and develop at least acquisition outline 140 to mitigate potential disruptions. Additionally, energy demand is closely linked to environmental conditions. In a non-limiting example, prediction module 144 may receive as input data on temperature and weather patterns to generate acquisition outline that forecasts the demand for heating oil, natural gas, and electricity. During cold winters, the demand for heating fuels increases, while hot summers drive up the need for electricity for air conditioning. Environmental data 168 thus provides prediction module 144 with useful information to estimate future demand more accurately, ensuring adequate supply and optimizing pricing strategies. Furthermore, the push for sustainable practices is informed by data on emissions, pollution levels, and resource consumption. Prediction module 144 may use this information to comply with regulations and adopt environmentally friendly practices, which can affect the demand for sustainable fungible assets like carbon credits or renewable energy certificates. In another non-limiting example, trends in climate change, for instance, may impact the long-term availability and price stability of certain fungible assets. By incorporating environmental risks and opportunities into the analysis, prediction module 144 may generate acquisition outlines with detailed information regarding where to allocate capital, manage risks, optimize supply chains, and make strategic decisions.

With continued reference to FIG. 1, wherein processing, using the processor, the plurality of multimodal data 112 comprises normalizing the plurality of multimodal data 112, wherein normalizing the plurality of multimodal data 112 comprises converting multimodal data 112 into a standard format.

As used in this disclosure, a “standard format” is a consistent and uniform structure used to represent data, making it easier to process, analyze, and integrate from various sources. In a non-limiting example, normalizing the plurality of multimodal data 112 may involve converting different types of data into standard format 172 that the processor can efficiently handle. For example, without limitation, when normalizing the plurality of multimodal data 112, numerical data might be converted into a common unit of measurement, such as converting different currencies into a single currency for financial analysis. Continuing, text data may be standardized by converting all characters to lowercase and removing punctuation to facilitate text mining and sentiment analysis. Continuing, image data might be resized to a consistent resolution and format, such as converting all images to 256×256 pixels in PNG format, to ensure compatibility with image processing algorithms. Continuing, sensor data from various sources may be synchronized to a common timestamp format, allowing for accurate temporal analysis. By converting multimodal data 112 into a standard format, the processor can more effectively analyze the data, identify patterns, and generate meaningful insights.

With continued reference to FIG. 1, any input data described herein may be transformed into a numerical representation using text vectorization, embedding, or feature extraction, to allow the machine learning model to process the data. In a nonlimiting example, input data may be transformed into numerical representations using vectors and/or matrices.

A “vector” as defined in this disclosure is a data structure that represents one or more quantitative values and/or measures the position vector. Such vector and/or embedding may include and/or represent an element of a vector space; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm:

$$l = \sqrt{{\sum }_{i = 0}^{n} {a}_{i}^{2} ,}$$

where ai is attribute number i of the vector. Scaling and/or normalization may function to make vector comparison independent of absolute quantities of attributes, while preserving any dependency on similarity of attributes. A two-dimensional subspace of a vector space may be defined by any two orthogonal vectors contained within the vector space. Two-dimensional subspace of a vector space may be defined by any two orthogonal and/or linearly independent vectors contained within the vector space; similarly, an n-dimensional space may be defined by n vectors that are linearly independent and/or orthogonal contained within a vector space. A vector's “norm’ is a scalar value, denoted |a| indicating the vector's length or size, and may be defined, as a non-limiting example, according to a Euclidean norm for an n-dimensional vector a as:

$$‖ a ‖ = \sqrt{{\sum }_{i = 0}^{n} {a}_{i}^{2}}$$

As used in this disclosure “matrix” is a rectangular array or table of numbers, symbols, expressions, vectors, and/or representations arranged in rows and columns. For instance, and without limitation, matrix may include rows and/or columns comprised of vectors representing [whatever data in your case], where each row and/or column is a vector representing a distinct [data element]; [data element] represented by vectors in matrix may include all [an example of data element] as described above as [how the example data element is generated, identified, or determined], including without limitation [another example of data element] as described above. As a non-limiting example matrix may include [an example relationships between plurality of data elements].

Matrix may be generated by performing a singular value decomposition function. As used in this disclosure a “singular value decomposition function” is a factorization of a real and/or complex matrix that generalizes the eigen decomposition of a square normal matrix to any matrix of m rows and n columns via an extension of the polar decomposition. For example, and without limitation singular value decomposition function may decompose a first matrix, A, comprised of m rows and n columns to three other matrices, U, S, T, wherein matrix U, represents left singular vectors consisting of an orthogonal matrix of m rows and m columns, matrix S represents a singular value diagonal matrix of m rows and n columns, and matrix VT represents right singular vectors consisting of an orthogonal matrix of n rows and n columns according to the vectors consisting of an orthogonal matrix of n rows and n columns according to the function:

$${A}_{mxn} = {U}_{mxm} {S}_{mxn} {V}_{nxn}^{T}$$

singular value decomposition function may find eigenvalues and eigenvectors of AA^{T} and A^{T}A. The eigenvectors of A^{T}A may include the columns of VT, wherein the eigenvectors of AA^{T} may include the columns of U. The singular values in S may be determined as a function of the square roots of eigenvalues AA^{T} or A^{T}A, wherein the singular values are the diagonal entries of the S matrix and are arranged in descending order. Singular value decomposition may be performed such that a generalized inverse of a non-full rank matrix may be generated.

With continued reference to FIG. 1, identifying at least a correlation 176 may include computing, using correlation module 120, correlation coefficient 136 between first variable 128 and second variable 132. As used in this disclosure, a “correlation” is a statistical relationship between two or more variables, indicating how the variables move in relation to each other. In a non-limiting example, at least a correlation 176 may reveal whether changes in one variable are related to changes in another, providing insights into their interdependencies. In another non-limiting example, at least a correlation 176 may be positive, negative, or neutral, and their strength may vary, helping to understand the degree of connection between the variables. For example, correlation module 120 may determine at least a correlation 176 between sales revenue (first variable 128) and advertising expenditure (second variable 132). Continuing, if increased advertising expenditure tends to be followed by higher sales revenue, this positive association may suggest that advertising may influence sales. Correlation module 120 may then compute correlation coefficient 136, which quantifies this relationship, and store it in correlation matrix 124 for further analysis by prediction module 144. In another non-limiting example, at least a correlation 176 between temperature (first variable 128) and energy consumption (second variable 132). Continuing, if higher temperatures lead to increased use of air conditioning and thus higher energy consumption, correlation module 120 may identify this positive association. Continuing, correlation module 120 may compute correlation coefficient 136 as 0.8 to indicate the strength of this relationship, and provide valuable information for input data for prediction module 144 to predict future energy requirements based on temperature forecasts.

With continued reference to FIG. 1, wherein computing correlation coefficient 136 further comprises dynamically updating, using temporal datum 180, first variable 128 and second variable 132, and re-computing, using correlation module 120, a second correlation coefficient 136 between the updated first variable 128 and the updated second variable 132. As used in this disclosure, a “temporal datum” is information that includes a time component. In a non-limiting example, temporal datum 180 may include a timestamp or time reference that permits the tracking and analysis of changes over time. In another non-limiting example, temporal datum 180 may enable the dynamic updating of variables, facilitating real-time analysis and decision-making processes. In another non-limiting example, temporal datum 180 may be used to continuously update the values of first variable 128 and second variable 132 as new data points are recorded over time. Continuing, this allows for correlation module 120 to re-compute correlation coefficient 136 dynamically, reflecting the most current association between the variables. Without limitation, if a company is analyzing the relationship between daily sales and daily marketing spend, each temporal datum would include the specific date on which sales and marketing expenditures were recorded. Continuing, by using these timestamps, correlation module 120 may track how the relationship evolves, providing up-to-date insights into the effectiveness of marketing efforts. In another non-limiting example, prediction module 144 may be required to predict energy consumption in a building. Continuing, each temporal datum may represent hourly temperature readings and corresponding energy usage data. Continuing, by including these timestamps, correlation module 120 may continuously update the relationship between temperature and energy consumption, allowing correlation module 120 to re-compute correlation coefficient 136 dynamically. Continuing, this real-time analysis may help prediction module 144 in optimizing energy use based on changing temperature patterns, improving energy efficiency, and reducing costs.

With continued reference to FIG. 1, wherein at least acquisition outline 140 may include plurality of temporal datums 180, each one of the plurality of temporal datums is associated with quantity datum 184 and a provider datum. As used in this disclosure, a “quantity datum” is information related to a specific amount of a particular fungible asset to be acquired, utilized, or managed. In a non-limiting example, quantity datum 184 may include exact volume, weight, or count of fungible asset 116 in question. Quantity datum 184 may be important to the at least acquisition outline 140 because it provides strategic information related to the precise planning and inventory control of fungible asset 116. For example, without limitation, quantity datum 184 may specify 5,000 barrels of crude oil to be purchased over the next quarter. Continuing, this quantity datum is critical for aligning supply chain operations with the budget and meeting production requirements. As used in this disclosure, a “supplier datum” is information related to a specific provider, individual, or entity to source fungible asset 116. In a non-limiting example, supplier datum 188 may include details including the supplier's name, address, contact information, and the like. In another non-limiting example, supplier datum 188 may indicate that the 5,000 barrels of crude oil are to be sourced from X Oil Company, located in X state. Continuing, supplier datum 188 may play a critical role in the execution of acquisition outline 140, reliability of the supply chain, maintaining consistent quality standards, strategic pricing, and the like.

With continued reference to FIG. 1, wherein the second fungible asset may be associated with a geographical datum. As used in this disclosure, a “geographical datum” is information that identifies the geographic location and characteristics of natural or constructed features and boundaries on the Earth. In a non-limiting example, this data may include coordinates (latitude and longitude), altitude, addresses, and descriptions of physical attributes such as rivers, roads, and land use. Without limitation, the second fungible asset 116 may be associated with crude oil prices in Boston.

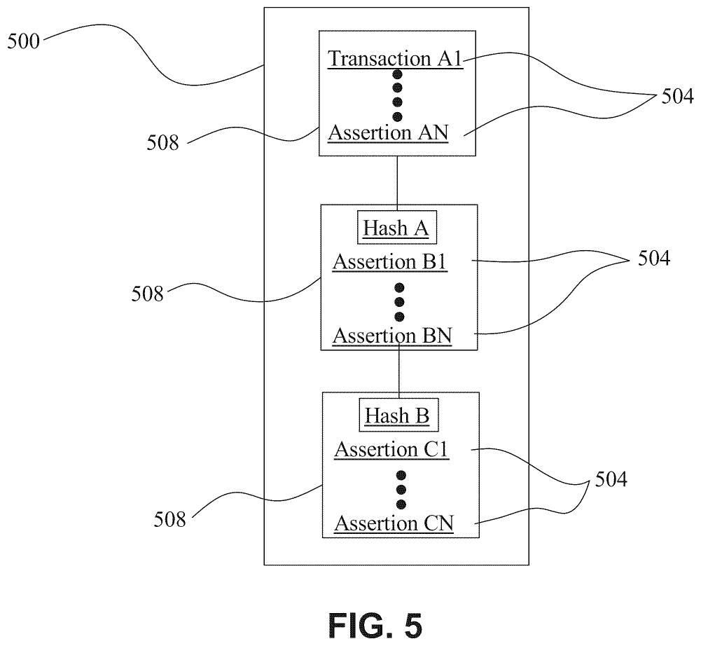

With continued reference to FIG. 1, apparatus 100 may include an immutable sequence listing, wherein the immutable sequence listing is configured to automatically execute a smart contract based on a predefined threshold. As used in this disclosure, an “immutable sequence listing” is a fixed, unchangeable sequence of data or elements that is recorded and maintained in a specific order. In a non-limiting example, a logistics company may use an immutable sequence listing to manage its fuel hedging strategy. Continuing, the immutable sequence listing may record all fuel purchase transactions, ensuring that the order of purchases remains constant and unaltered for accurate financial tracking and auditing. Continuing, this may help the company maintain a transparent and tamper-proof record of fuel costs, enabling better forecasting and risk management. In another non-limiting example, a blockchain ledger may employ an immutable sequence listing to record transactions in a fixed chronological order, providing a reliable and tamper-proof record of all activities. Without limitation, the immutable sequence listing is described in more detail in FIG. 5. As used in this disclosure, a “smart contract” is a self-executing contract with terms of the agreement directly written into the code. In a non-limiting example, the smart contract terms may be enforced and executed when predetermined conditions are satisfied. For example, without limitation, a smart contract may automatically release payment to a freelancer once the project milestones are completed and approved, ensuring timely and transparent business transactions. In another non-limiting example, the smart contract for the automatic transfer of property ownership may facilitate the transaction between the buyer's payment and seller's property deed. Without limitation, the smart contract, terms and conditions may be stored on the immutable sequence listing to reduce the need for intermediaries and to speed up the transaction process among parties. As used in this disclosure, a “predefined threshold” is a specific value or limit set in advance to trigger a particular action or decision when exceeded or not met. In a non-limiting example, the predefined threshold may set a predefined threshold for the cost per unit of purchasing a specific fungible asset, such as crude oil, at $70 per barrel. If the market price drops below this threshold, prediction module 144 may recommend increasing purchases to capitalize on the lower cost, whereas if the price exceeds this threshold, it may suggest holding off on purchases to avoid higher expenses. Continuing, without limitation, the immutable sequence listing may ensure that all recorded events and transactions are tamper-proof and transparent, providing a reliable historical record of asset prices and acquisition activities. Continuing, when the price of crude oil hits the predefined threshold of $70 per barrel, this event is recorded in the sequence listing, triggering the smart contract to execute without the need for manual intervention. Continuing, the smart contract may be designed to automatically purchase crude oil when the price drops below $70 per barrel. Continuing the previous non-limiting example, this not only ensures timely and cost-effective acquisitions but also eliminates human error and enhances efficiency. Conversely, if the price exceeds $70, the smart contract may halt further purchases to prevent overspending. Continuing, by leveraging the immutable sequence listing, the smart contract can verify and validate the price data against historical records before executing transactions, ensuring compliance with the established financial strategies and thresholds. This integration of predefined thresholds within immutable sequence listings and smart contracts may provide a robust and automated solution for managing fungible asset acquisitions.

With continued reference to FIG. 1, in a non-limiting example, the immutable sequence listing may store the digital signatures required for the smart contract execution to ensure security, authenticity, and traceability of transactions. Continuing, each entry in the immutable sequence listing may include a digital signature, which may serve as a unique identifier verifying the origin and integrity of the data. Continuing, these digital signatures may be generated using cryptographic techniques, ensuring that each transaction is securely signed and cannot be altered once recorded. Continuing, when a predefined threshold triggers the smart contract, the digital signatures stored within the immutable sequence listing may be used to authenticate and validate the transaction. For example, when the price of crude oil falls below $70 per barrel, the smart contract may cross-reference the digital signatures in the sequence listing to confirm that the price data is accurate and has not been tampered with. Without limitation, this process may involve verifying the signatures against public keys stored in the system, ensuring that only authorized entities can initiate or approve transactions. Without limitation, by leveraging digital signatures, the immutable sequence listing may provide a transparent and secure mechanism for recording and validating all steps of the smart contract execution. Continuing, this approach may help prevent fraud and unauthorized access, as any attempt to alter a transaction would invalidate the corresponding digital signature.

With continued reference to FIG. 1, prediction module 144 may include a plurality of prediction models configured develop the at least an acquisition outline and assign each of the at least an acquisition outlines a score. As used in this disclosure, a “prediction model” is an algorithm designed to forecast future events of outcomes based on historical data and identified patters. In a non-limiting example, plurality of prediction models 192 may be configured to generate at least acquisition outline 140 by analyzing various events. As used in this disclosure, a “score” is a numerical value of the probability of an event occurring. As used in this disclosure, an “event” is a hypothetical situation or sequence of events used to analyze and predict potential outcomes and guide decision-making. For example, without limitation, an event may involve a sudden increase in demand for a product, prompting prediction module 144 to assess the impact on inventory levels and production capacity. In another non-limiting example, an event may consider the introduction of new regulations affecting supply chain operations, leading prediction module 144 to evaluate and optimize compliance strategies and resource allocation. As used in this disclosure, a “potential outcome” is a possible result or scenario that may occur as a consequence of a specific event or set of conditions. For example, the prediction model may consider a potential outcome where a sudden increase in demand for a product leads to higher prices and supply shortages. In another non-limiting example, the potential outcome might be a decrease in production costs due to technological advancements, resulting in increased profit margins and lower market prices. For instance, without limitation, a prediction model may identify various potential outcomes based on events such as a specific storm or market agreement and assign probabilities to each event. Continuing, the prediction model may generate and optimize at least acquisition outline 140 based on each event. In a non-limiting example, the event may include a 50% probability of a storm impacting the coast of a lumber town, significantly increasing the cost of lumber after a specified date. Concurrently, there may be a 50% probability that the cost of lumber will decrease if an agreement is reached with an cast coast lumber town by that same date. Without limitation, the prediction model may generate two distinct acquisition outlines to accommodate the two potential outcomes. Without limitation, one acquisition outline may recommend securing lumber supplies prior to the anticipated storm date to avoid potential price increases, thus optimizing for cost stability, whereas the alternative acquisition outline may advise delaying purchases until after the specified date, anticipating a decrease in lumber prices if the deal is finalized. Continuing, by presenting these two acquisition outlines, the prediction model enable the user to select the most appropriate strategy based on their risk tolerance and operational requirements. For example, a score of 0.8 may indicate an 80% probability that a specific market condition will occur, influencing the acquisition strategy. Conversely, a score of 0.2 may indicate a 20% probability, suggesting a lower likelihood of that event impacting acquisition outline 140.

With continued reference to FIG. 1, plurality of prediction models 192 are further configured to identify a second correlation 196 and adjust at least an acquisition outline 140 based on the second correlation 196. For example, second correlation 196 may be generated as a result of a comparison between at least an acquisition outline 140 and an actual outcome. Continuing, second correlation 196 may be used to adjust future acquisition outlines. As used in this disclosure, a “future acquisition outline” is a strategic plan developed for procuring resources and assets at a later date, based on predicted needs and market conditions. For example, without limitation prediction module 144 may generate a future acquisition outline for a manufacturing entity to secure raw materials needed for production over the next quarter, taking into account projected demand and supplier availability. Without limitation, prediction models 192 may adjust the future acquisition outline if the actual material costs or delivery times differ significantly from the initial plan, ensuring the company remains adaptable and efficient in its procurement strategies. As used in this disclosure, an “actual outcome” is the real result or occurrence that happens after implementing a specific plan or strategy, as opposed to the predicted or anticipated outcome. For example, without limitation, if prediction models 192 forecast a 10% increase in raw material costs, but second correlation 196 is a 15% increase, prediction models 192 may compare this difference and adjust future acquisition outlines to account for higher costs. In another non-limiting example the prediction model may anticipate a 5% decrease in energy consumption, but second correlation 196 was a 3% decrease. Continuing, the prediction model may use that difference of 2% (5%−3%) to refine the future acquisition outline and acquisition strategies accordingly.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

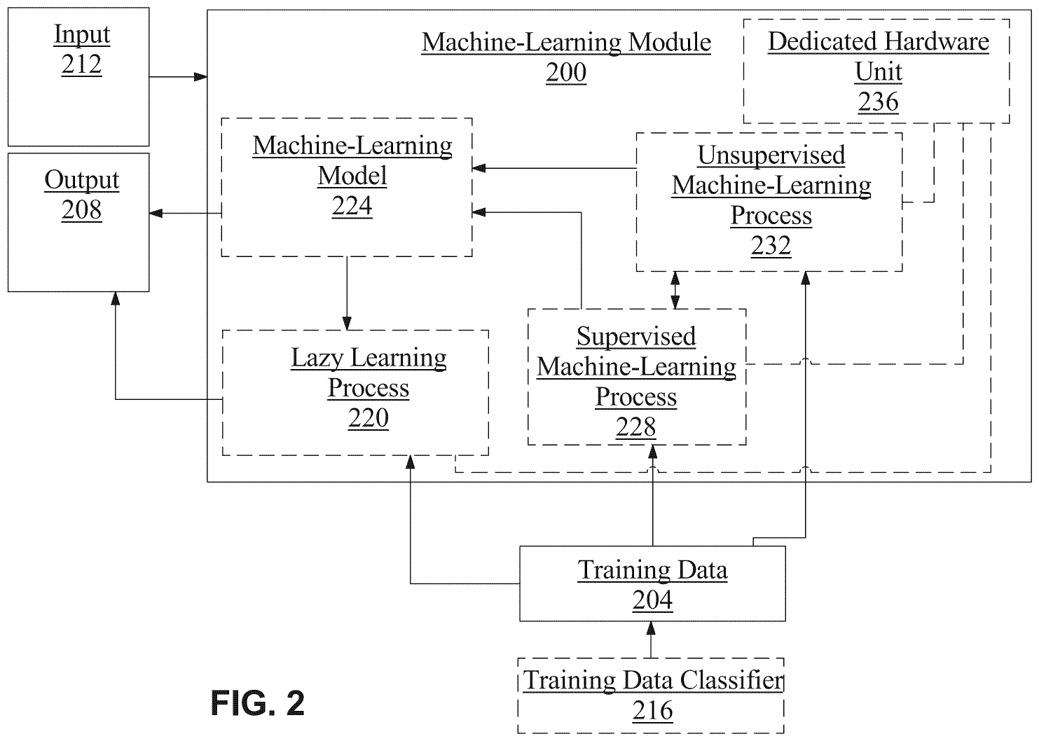

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs may include the plurality of multimodal data 112 and outputs may include the acquisition outline.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data geographical cohorts, volatility cohorts, temporal cohorts, sector cohorts, and the like.

Still referring to FIG. 2, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2} ,}$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 2, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 2, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 2, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{I Q R} .$$

Persons skilled in the art, upon reviewing the entirety of this disclosure, will be aware of various alternative or additional approaches that may be used for feature scaling.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include the plurality of multimodal data 112 as described above as inputs, at least an acquisition outline as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

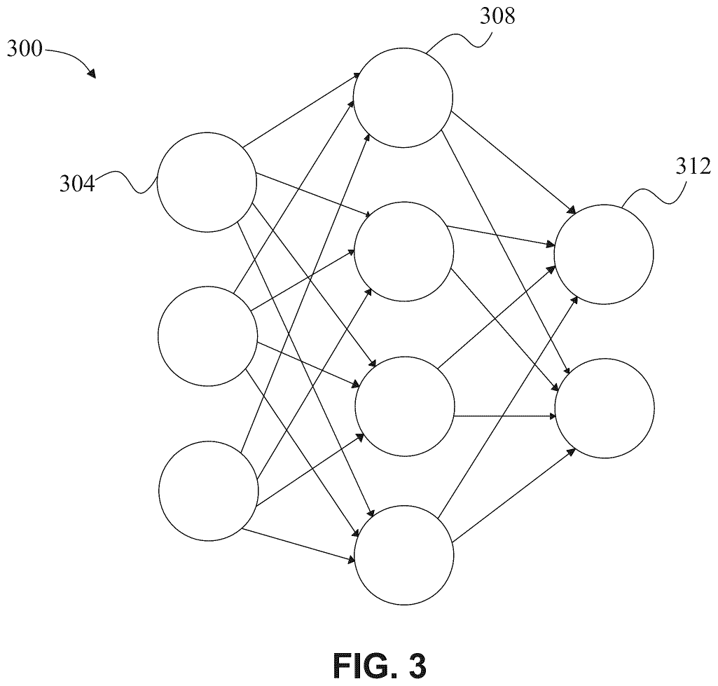

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

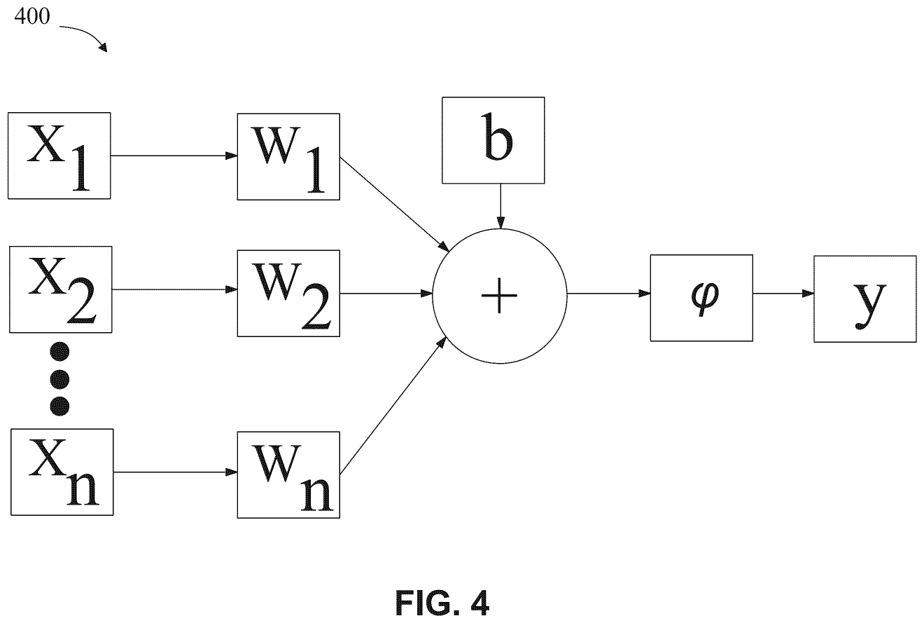

Referring now to FIG. 4, an exemplary embodiment of a node 400 of a neural network is illustrated. A node may include, without limitation, a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max(0,x), a “leaky” and/or “parametric” rectified linear unit function such as ƒ(x)=max (ax,x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tan h(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input x; may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring now to FIG. 5, an exemplary embodiment, 500, of an immutable sequential listing is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

Data elements are listed in immutable sequential listing 500; data elements may include any form of data, including textual data, image data, encrypted data, cryptographically hashed data, and the like. Data elements may include, without limitation, one or more at least a digitally signed assertions. In one embodiment, a digitally signed assertion 504 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 504. In an embodiment, collection of textual data states that the owner of a certain transferable item represented in a digitally signed assertion 504 register is transferring that item to the owner of an address. A digitally signed assertion 504 may be signed by a digital signature created using the private key associated with the owner's public key, as described above.

Still referring to FIG. 5, a digitally signed assertion 504 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g., a ride share vehicle or any other asset. A digitally signed assertion 504 may describe the transfer of a physical good; for instance, a digitally signed assertion 504 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 504 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 5, in one embodiment, an address is a textual datum identifying the recipient of virtual currency or another item of value in a digitally signed assertion 504. In some embodiments, address is linked to a public key, the corresponding private key of which is owned by the recipient of a digitally signed assertion 504. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 504 may record a subsequent a digitally signed assertion 504 transferring some or all of the value transferred in the first a digitally signed assertion 504 to a new address in the same manner. A digitally signed assertion 504 may contain textual information that is not a transfer of some item of value in addition to, or as an alternative to, such a transfer. For instance, as described in further detail below, a digitally signed assertion 504 may indicate a confidence level associated with a distributed storage node as described in further detail below.

In an embodiment, and still referring to FIG. 5 immutable sequential listing 500 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 500 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 5, immutable sequential listing 500 may preserve the order in which the at least a posted content took place by listing them in chronological order; alternatively or additionally, immutable sequential listing 500 may organize digitally signed assertions 504 into sub-listings 508 such as “blocks” in a blockchain, which may be themselves collected in a temporally sequential order; digitally signed assertions 504 within a sub-listing 508 may or may not be temporally sequential. The ledger may preserve the order in which at least a posted content took place by listing them in sub-listings 508 and placing the sub-listings 508 in chronological order. The immutable sequential listing 500 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 500 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 5, immutable sequential listing 500, once formed, may be inalterable by any party, no matter what access rights that party possesses. For instance, immutable sequential listing 500 may include a hash chain, in which data is added during a successive hashing process to ensure non-repudiation. Immutable sequential listing 500 may include a block chain. In one embodiment, a block chain is immutable sequential listing 500 that records one or more new at least a posted content in a data item known as a sub-listing 508 or “block.” An example of a block chain is the BITCOIN block chain used to record BITCOIN transactions and values. Sub-listings 508 may be created in a way that places the sub-listings 508 in chronological order and link each sub-listing 508 to a previous sub-listing 508 in the chronological order so that any computing device may traverse the sub-listings 508 in reverse chronological order to verify any at least a posted content listed in the block chain. Each new sub-listing 508 may be required to contain a cryptographic hash describing the previous sub-listing 508. In some embodiments, the block chain contains a single first sub-listing 508 sometimes known as a “genesis block”.

Still referring to FIG. 5, the creation of a new sub-listing 508 may be computationally expensive; for instance, the creation of a new sub-listing 508 may be designed by a “proof of work” protocol accepted by all participants in forming the immutable sequential listing 500 to take a powerful set of computing devices a certain period of time to produce. Where one sub-listing 508 takes less time for a given set of computing devices to produce the sub-listing 508 protocol may adjust the algorithm to produce the next sub-listing 508 so that it will require more steps; where one sub-listing 508 takes more time for a given set of computing devices to produce the sub-listing 508 protocol may adjust the algorithm to produce the next sub-listing 508 so that it will require fewer steps. As an example, protocol may require a new sub-listing 508 to contain a cryptographic hash describing its contents; the cryptographic hash may be required to satisfy a mathematical condition, achieved by having the sub-listing 508 contain a number, called a nonce, whose value is determined after the fact by the discovery of the hash that satisfies the mathematical condition. Continuing the example, the protocol may be able to adjust the mathematical condition so that the discovery of the hash describing a sub-listing 508 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 508 according to the protocol is known as “mining.” The creation of a new sub-listing 508 may be designed by a “proof of stake” protocol as will be apparent to those skilled in the art upon reviewing the entirety of this disclosure.

Continuing to refer to FIG. 5, in some embodiments, protocol also creates an incentive to mine new sub-listings 508. The incentive may be financial; for instance, successfully mining a new sub-listing 508 may result in the person or entity that mines the sub-listing 508 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 508 Each sub-listing 508 created in immutable sequential listing 500 may contain a record or at least a posted content describing one or more addresses that receive an incentive, such as virtual currency, as the result of successfully mining the sub-listing 508.

With continued reference to FIG. 5, where two entities simultaneously create new sub-listings 508, immutable sequential listing 500 may develop a fork; protocol may determine which of the two alternate branches in the fork is the valid new portion of the immutable sequential listing 500 by evaluating, after a certain amount of time has passed, which branch is longer. “Length” may be measured according to the number of sub-listings 508 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 508 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 500 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 500.

Still referring to FIG. 5, additional data linked to at least a posted content may be incorporated in sub-listings 508 in the immutable sequential listing 500; for instance, data may be incorporated in one or more fields recognized by block chain protocols that permit a person or computer forming a at least a posted content to insert additional data in the immutable sequential listing 500. In some embodiments, additional data is incorporated in an unspendable at least a posted content field. For instance, the data may be incorporated in an OP_RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 5, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 508 in a block chain computationally challenging; the incentive for producing sub-listings 508 may include the grant of new crypto-currency to the miners. Quantities of crypto-currency may be exchanged using at least a posted content as described above.

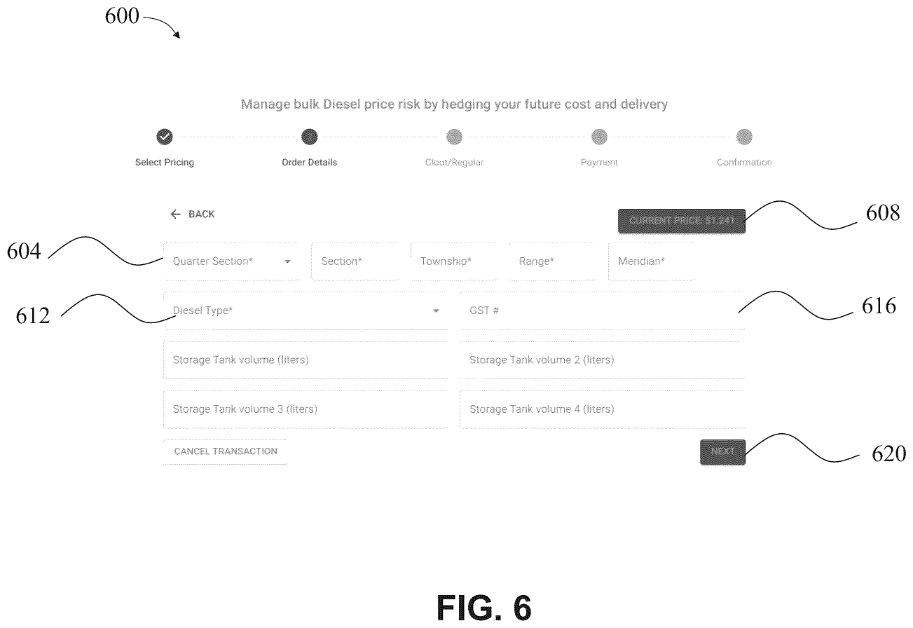

Referring now to FIG. 6, an exemplary illustration, 600, of a graphical user interface designed for managing bulk diesel price risk by hedging future cost and delivery. In an embodiment, graphical user interface 600 may include several interactive components such as selection panel 604, diesel type dropdown 612, current price display 608, GST input field 616, and navigation button 620. In an embodiment, selection panel 604 may allow users to input various geographical parameters including quarter section, section, township, range, and meridian. In a non-limiting example, these fields may enable precise location-based data entry for diesel delivery. In an embodiment, diesel type dropdown 612 may provide a selection mechanism for users to choose the type of diesel required. In a non-limiting example, this dropdown may ensure that the correct type of diesel is selected for the transaction. In an embodiment, current price display 608 shows the current price of diesel per unit. In a non-limiting example, this display may provide real-time pricing information to the user, aiding in informed decision-making. In an embodiment, GST input field 616 allows users to enter their GST number. In a non-limiting example, this field may ensure that the transaction complies with tax regulations and facilitates proper billing. In an embodiment, navigation button 620, labeled “NEXT,” enables users to proceed to the next step in the transaction process. In a non-limiting example, this button guides users through the multi-step process of managing bulk diesel price risk.

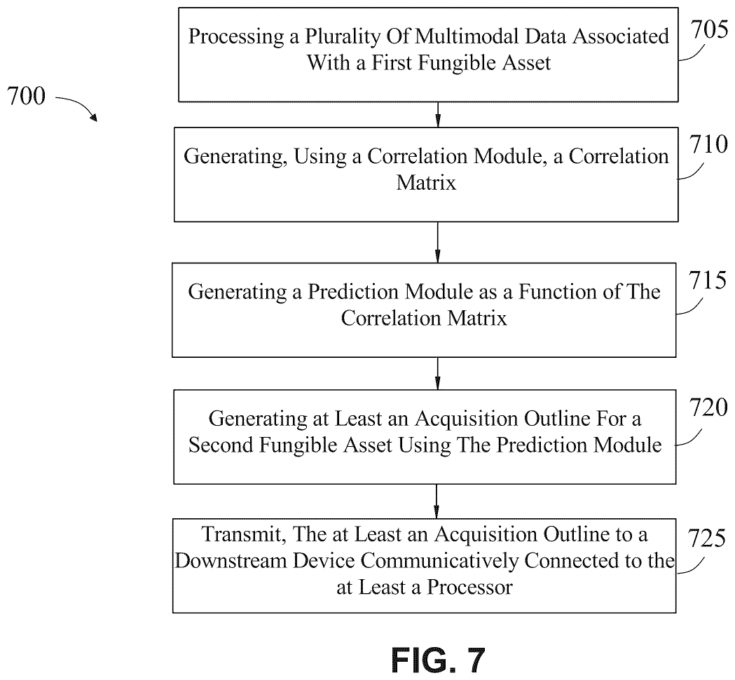

Referring now to FIG. 7, a flow diagram of an exemplary method, 700, for predicting fungible asset requirement using statistical relationship modeling is illustrated. At step 705, method 700 includes processing a plurality of multimodal data associated with a first fungible asset. This may be implemented as described and with reference to FIGS. 1-6.

Still referring to FIG. 7, at step 710, method 700 includes generating, using a correlation module, a correlation matrix, as a function of the plurality of multimodal data, wherein generating the correlation matrix comprises comparing a first variable of the plurality of input data to a second variable of the plurality of multimodal data, identifying at least a correlation between the first variable and the second variable based on the comparison, and generating the correlation matrix as a function of the at least a correlation. This may be implemented as described and with reference to FIGS. 1-6.

Still referring to FIG. 7, at step 715, method 700 generating a prediction module as a function of the correlation matrix. This may be implemented as described and with reference to FIGS. 1-6.

Still referring to FIG. 7, at step 720, method 700 generating at least an acquisition outline for a second fungible asset using the prediction module. This may be implemented as described and with reference to FIGS. 1-6.

Still referring to FIG. 7, at step 725, method 700 transmitting the at least an acquisition outline to a downstream device communicatively connected to the at least a processor. This may be implemented as described and with reference to FIGS. 1-6. In an embodiment, wherein the downstream device may include a remote device, the apparatus, and or shared devices.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

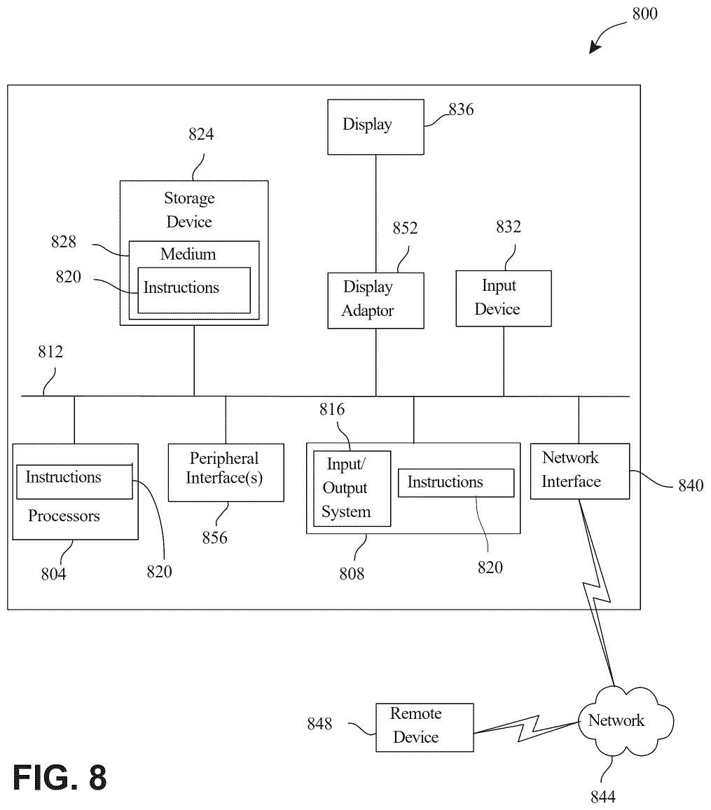

FIG. 8 shows a diagrammatic representation of one embodiment of computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 924 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for predicting fungible asset requirement using statistical relationship modeling, wherein the apparatus comprises:
a memory; and
at least a processor communicatively connected to the memory, wherein the memory contains instructions configuring the at least a processor to:
process a plurality of multimodal data associated with a first fungible asset;
generate, using a correlation module, a correlation matrix as a function of the plurality of multimodal data, wherein generating the correlation matrix comprises:
comparing a first variable of the plurality of multimodal data to a second variable of the plurality of multimodal data;
computing at least a correlation coefficient between the first variable and the second variable based on the comparison, wherein computing the at least a correlation coefficient comprises:
updating, using a temporal datum, the first variable and the second variable, wherein the temporal datum is configured to iteratively update one or more values of the first variable and the second variable, wherein the temporal datum comprises at least a timestamp associated with the plurality of multimodal data;
iteratively recomputing, using the correlation module, a second correlation coefficient between the updated first variable and the updated second variable; and
generating the correlation matrix as a function of the at least a correlation coefficient;
generate a prediction module as a function of the correlation matrix using the correlation coefficient generated by the updated correlation module, wherein generating the prediction module comprises using an iteratively trained machine learning model using a plurality of training data as input, wherein the machine learning model is configured to receive the correlation matrix generated as a function of the correlation coefficient using the updated correlation module and output at least an acquisition outline for a second fungible asset, and wherein iteratively training the machine learning model comprises:
training the machine learning model using the plurality of training data as input;
adjusting one or more connections and one or more weights between nodes in adjacent layers of the machine learning model; and
retraining the machine learning model as a function of the correlations to produce the output layer of nodes;
generate at least an acquisition outline for a second fungible asset using the prediction module, wherein the acquisition outline comprises a purchase schedule of a plan for fungible asset procurement; and
transmit the at least an acquisition outline to a downstream device communicatively connected to the at least a processor.

2. The apparatus of claim 1, wherein the at least a processor is further configured to receive the plurality of multimodal data using one or more of a web crawler and a user input.

3. The apparatus of claim 1, wherein the plurality of multimodal data comprises a plurality of fiscal data, sector data, and environmental data.

4. The apparatus of claim 1, wherein processing the plurality of multimodal data comprises normalizing the plurality of multimodal data, wherein normalizing the plurality of multimodal data comprises converting the plurality of multimodal data into a standard data format.

5. The apparatus of claim 1, wherein identifying the at least a correlation comprises computing, using the correlation module, a correlation coefficient between the first variable and the second variable.

6. (canceled)

7. The apparatus of claim 1, wherein the second fungible asset is associated with a geographical datum.

8. The apparatus of claim 1, wherein the at least an acquisition outline comprises a plurality of temporal datums, each one of the plurality of temporal datums is associated with a quantity datum and a provider datum.

9. The apparatus of claim 1, wherein the prediction module comprises a plurality of prediction models, each one of the plurality of prediction models is configured to:
generate the at least an acquisition outline; and
assign the at least an acquisition outline a score.

10. The apparatus of claim 9, wherein the plurality of prediction models are further configured to:
identify a second correlation; and
adjust the at least an acquisition outline based on the second correlation.

11. A method for predicting fungible asset requirement using statistical relationship modeling, wherein the method comprises:
processing, using at least a processor, a plurality of multimodal data associated with a first fungible asset;
generating, using a correlation module, a correlation matrix as a function of the plurality of multimodal data, wherein generating the correlation matrix comprises:
comparing a first variable of the plurality of multimodal data to a second variable of the plurality of multimodal data;
computing at least a correlation coefficient between the first variable and the second variable based on the comparison, wherein computing the at least a correlation coefficient comprises:
updating, using a temporal datum, the first variable and the second variable, wherein the temporal datum is configured to iteratively update one or more values of the first variable and the second variable, wherein the temporal datum comprises at least a timestamp associated with the plurality of multimodal data;
iteratively re-computing, using the correlation module, a second correlation coefficient between the updated first variable and the updated second variable; and
generating the correlation matrix as a function of the at least a correlation coefficient;
generating, using the at least a processor, a prediction module as a function of the correlation matrix using the correlation coefficient generated by the updated correlation module, wherein generating the prediction module comprises using an iteratively trained machine learning model using a plurality of training data as input, wherein the machine learning model is configured to receive the correlation matrix generated as a function of the correlation coefficient using the updated correlation module and output at least an acquisition outline for a second fungible asset, and wherein iteratively training the machine learning model comprises:
training the machine learning model using the plurality of training data as input;
adjusting one or more connections and one or more weights between nodes in adjacent layers of the machine learning model; and
retraining the machine learning model as a function of the correlations to produce the output layer of nodes;
generating, using the at least a processor, at least an acquisition outline for a second fungible asset using the prediction module, wherein the acquisition outline comprises a purchase schedule of a plan for fungible asset procurement; and
transmitting, using the at least a processor, the at least an acquisition outline to a downstream device communicatively connected to the at least a processor.

12. The method of claim 11, further comprising receiving the plurality of multimodal data using one or more of a web crawler and a user input.

13. The method of claim 11, wherein the plurality of multimodal data comprises a plurality of fiscal data, sector data, and environmental data.

14. The method of claim 11, wherein processing, using the at least a processor, the plurality of multimodal data comprises normalizing the plurality of multimodal data, wherein normalizing the plurality of multimodal data comprises converting the plurality of multimodal data into a standard data format.

15. The method of claim 11, wherein identifying the at least a correlation comprises computing, using the correlation module, a correlation coefficient between the first variable and the second variable.

16. (canceled)

17. The method of claim 11, wherein the second fungible asset is associated with a geographical datum.

18. The method of claim 11, wherein the at least an acquisition outline comprises a plurality of temporal datums, each one of the plurality of temporal datums is associated with a quantity datum and a provider datum.

19. The method of claim 11, wherein the prediction module comprises a plurality of prediction models, each one of the plurality of prediction models is configured to:
generate the at least an acquisition outline; and
assign the at least an acquisition outline a score.

20. The method of claim 19, wherein the plurality of prediction models are further configured to:
identify a second correlation; and
adjust the at least an acquisition outline based on the second correlation.
